(19) United States
(12) Patent Application Publication
(10) Pub. No.: US 2021/0199765 A1
(43) Pub. Date: Jul. 1, 2021

(54) INTEGRAL ELECTRO-OPTICAL METER FOR MEASURING DISTANCES OF AUTOMOTIVE USE

(71) Applicant: Ernst Albert REMBERG BUENO, Naucalpan de Juárez, Estado de México (MX)

(72) Inventors: Ernst Albert REMBERG BUENO, Naucalpan de Juárez, Estado de México (MX); Herman DÍAZ ARIAS, Naucalpan de Juárez, Estado de México (MX)

(73) Assignee: Ernst Albert REMBERG BUENO, Naucalpan de Juárez, Estado de México (MX)

(21) Appl. No.: 16/494,060

(22) PCT Filed: Mar. 12, 2018
(86) PCT No.: PCT/MX2018/000018

§ 371 Date: Mar. 5, 2021

(30) Foreign Application Priority Data
Mar. 14, 2017 (MX) MX/A/2017/003334

(51) Int. Cl. G01S 7/481; G01S 17/08; G01S 17/931

(52) U.S. Cl. CPC G01S 7/4811; G01S 17/931; G01S 17/08

(57) ABSTRACT

The device of the present invention is an electro-optical distance meter that operates by reflecting a beam of light off of a target or object for which the distance from the meter is desired to be known. Unlike conventional optical time-of-flight meters, the beam of light in this case is a continuous sine signal that forms a functional part, including the path thereof, of a positive feedback line that feeds a high-gain amplifier that thus becomes an oscillator having a frequency proportional to the distance at which the object is located, the frequency-distance ratio being logarithmic. The circuit is essentially characterized in that, despite using light to evaluate distance, it does not require ultra-high-speed circuits but only conventional industrial-level, or even commercial-level, circuits, providing a low-cost solution to the need to estimate distances from a short range in a compact form.

### FIELD OF THE INVENTION

The present invention is developed in the field of electronic engineering, optical physics and mechanical engineering, the main development area being the optoelectronics.

### BACKGROUND OF THE INVENTION

The need for measuring distances between various objects either statically or dynamically, has been enhanced as long as the industry development, automation and transportation industry, have been developed over all in the last three decades, as well as various designs have appeared using magnetic, acoustic and optical sensor devices or sensors. Distance measuring devices based on magnetic fields, present as a major problem in their restricted operation at short distances, generally distances less than 20 cm and constitute more well sensors in the presence of high precision range measuring elements.

Acoustic type distance measuring devices are generally devices called flight time meters, such as sonar and sodan, in these cases, a sound pulse is emitted, generally in the ultrasonic range, in the direction of the object whose distance to the emitter is intended to know and knowing the velocity of propagation of the sound waves in the medium at which the measurement takes place it is relatively easy to determine the distance to the object by measuring the time it takes the pulse, it and come, this type of distance meters, allow not only the determination of the distance itself, but also by virtue of the use of the Doppler effect, also the relative speeds between the object and the measurement base; however, when these devices are used to establish distances between vehicles there are two factors that are definitely negative when evaluating their performance in this type of application, the first factor is the cost, which can be generally very high and the second problem is the frequent detection of undesired signals from recans or other similar sensors operating in the vicinity which can lead to erroneous measurements.

It is also very important to highlight the development which have had in the last decades the micro pulse radars such as the MIR (micro drive)) these devices were very promising in their origin, but the handling of the Spanish companies of the patents has made, focusing only to granting licenses to a few corporations, has limited its proliferation and widespread application.

In terms of optical distance meters, traditionally employed the triangulation or focusing process as compared, the latter procedure was very used in photographic cameras to the end of the past century, but none of these two techniques are suitable for use in transport vehicles, however in the last five years, optical distance sensors and meters based on the time of time measurement of flight have appeared this type of devices were very expensive during the 3th century, because the speed of the light is extremely high and the time it takes to a pulse of light ir, impact on a target and return to its emission source, is of femtosecond fractions and the electronics required to manipulate signals at these speeds was very expensive, the incorporation of interference techniques and the use of lasers, has allowed to cover all of these meters but still constitute a very expensive solution to the need to measure the distance between two vehicles or between two objects.

The invention relates to the solution of the invention and which is intended to be an object of the present invention, it employs low frequency electronics and can use either laser diodes or led diodes for distance measurements in the range between one and three centimeters using only modulated light and with a very low cost.

### SUMMARY OF THE INVENTION

The design described below is a solution to the need to measure short range distances with great precision, occupying a minimum space and a low cost. The electrooptic distance meter of the present invention consists of an electronic circuit including two stages of amplification, a light emitter which in its case may be a laser diode or a led, as well as a light detector which consists of a photodiode equipped with a lens that concentrates the incident light towards its focus on which the photodiode is located, the general architecture of this meter is completely different from traditional flight time meter schemes, specifically, the traditional flight time meter has an oscillator, a pulse generator and an emitter on one side and on the other hand, with a sensor, a filtering circuit, a timer, which determines the time required for the travel of the light pulse by running the distance of the meter to the target and from the target to the meter and finally, a device, generally a microsizer, which performs the basic operation of distance equal to the speed of the light between the time of flight; our design, counts with a completely different architecture consisting of a positively powered high gain circuit, which includes within the feedback path, the space traversed by the light pulse and whose length is directly incident on the behavior of the circuit, which basically behaves like a distance controlled oscillator.

This distance measuring circuit is designed to be used basically in vehicles, such as automobiles or trucks, for integrating a collision prevention system, especially for incorporation into a system for preventing damage to parked vehicles, system that allows to alert other approaching vehicles when the characteristics of this approach (speed, distance and trajectory) represent an impact hazard.

### DESCRIPTION OF THE FIGURES

FIG. 1 shows the electro optical distance measuring circuit using a microcontroller as a linearizer circuit.

FIG. 2 shows the electro optic distance measuring circuit using an assembly that constitutes a non linear voltage to voltage converter to compensate for the proper exponential non linearity of the sensor circuit.

FIG. 3 shows a comparison between a traditional optical distance measurement system for flight time and the electro optic design of the present invention.

### DETAILED DESCRIPTION OF THE INVENTION

The electro optical range meter for automotive use, the object of this invention is basically comprised of three blocks, the first is a collimating and lens assembly which allows to delimit the area of action of the light beam being generated in order to perform the measurement, the second element is an electronic circuit of high gain and critical stability, which, by providing a certain amount of positive feedback it enters the oscillation, resulting in a frequency which saves a logarithmic relationship with the distance between the measuring device, and a target whose distance is desired to be estimated, ultimately, the system has an Idealization unit which allows the response function to be re formed which establishes the relationship between the distance and output frequency of the meter to facilitate its practical application.

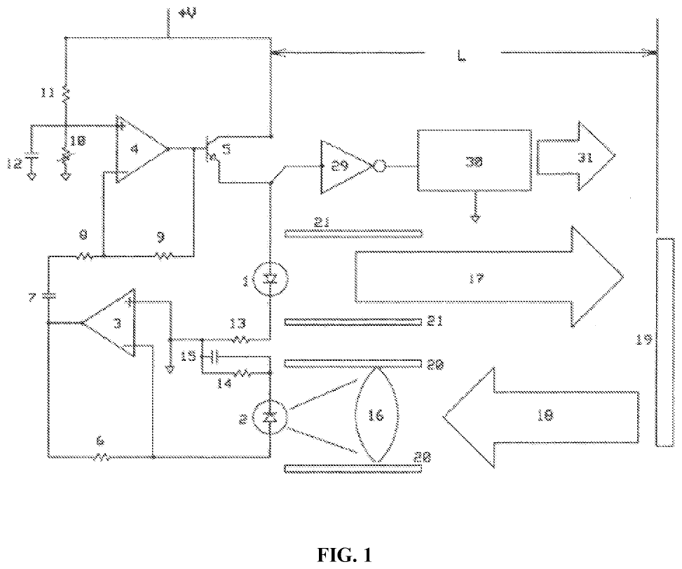

In FIG. 1, a schematic diagram of the entire system is shown and it is important to highlight that unlike conventional optical systems or optical devices for time distance measurement of flight, this design is based on a fully closed circuit, positively fed positively with critical stability and in which said positive feedback is provided by the light beam being emitted, which is returned to the target and is rerecorded by an optical sensor, in FIG. 1, the light emitting diode (1), emits what is subsequently seen to be an essentially sinusoidal signal, which traverses a trajectory towards the target (17), to impinge on the target (19), reflected in it and taking a return path (18) to impinge on the lens (16), which concentrates the light incident on the photodiode (2), placed in the focus of the lens (16), since the photodiode (2) it has a very low sensitivity it is necessary that the primary amplifier (3) operate in a high gain configuration in which the feedback resistance (6), determines the gain of this first amplification stage, the resistance (14) and the capacitor (15) working in parallel to limit the gain of DC but preserving a maximum gain Of AC, the output of the primary amplifier (3) is coupled by the coupling capacitor (7) to the secondary operational amplifier (4) which is formed as an inverting amplifier whose very high gain is determined by dividing the value of the resistance (9) between the value of the resistance (8); the coupling capacitor (7) and the resistance (8), in turn, contribute to establishing the frequency band within which the circuit can oscillate, the frequency of oscillation being proportional to the variations in the length of the paths (17), (18).

The level adjustment (10) allows to establish together with the polarization resistance (11) and the stabilizing capacitor (12), a Power level for the light emitting diode (1), since this level adjustment (10), allowing the initial level of the emitter of the current amplifier (5) to be varied, and from that voltage, the sinusoidal oscillation will be generated above and below the same, a limiting resistor (13), preventing the light emitting diode (1), exceeding the maximum allowed levels of current for it, this light emitting diode can be a simple led or a laser diode, depending on whether it is required for the final application of the distance meter, the cost or greater distance of operation.

In order to delimit and adequately cause the light beams, two tubes are used in the form of collimators, these are the input collimator (20) and the output collimator (21), in which the photodiode (2) and the light emitting diode (1) are housed, respectively. The Distance L between the meter and the target (19) is equal to the sum of the trajectory towards the target (17) and the return path (18) divided by two and is the variation of the length of these two partial paths, which can alter the positive feedback of the circuit, it is determined in order to obtain a variation in the oscillation frequency of the latter as a function of the total length traversed by the light beam after it has been emitted, Having rebound in the target and have been recorded back.

At the emitter of the transistor (5), the frequency signal is extracted which is proportional to the distance L, a Schmitt input inverter (29) allows the sine signal to be converted to the emitter of the transistor (S) in a square signal in order to provide this signal to the microcontroller (30) in which a linearization algorithm is previously programmed, since the relationship between the magnitude L that is the distance to the target and the frequency generated by the circuit it is a logarithmic function, thus the microcontroller (30), can emit an output signal (31) perfectly linearized as required for the final application (whether it is desired to have a value expressed in a binary number, a PWM signal or even a voltage signal directly proportional to the distance).

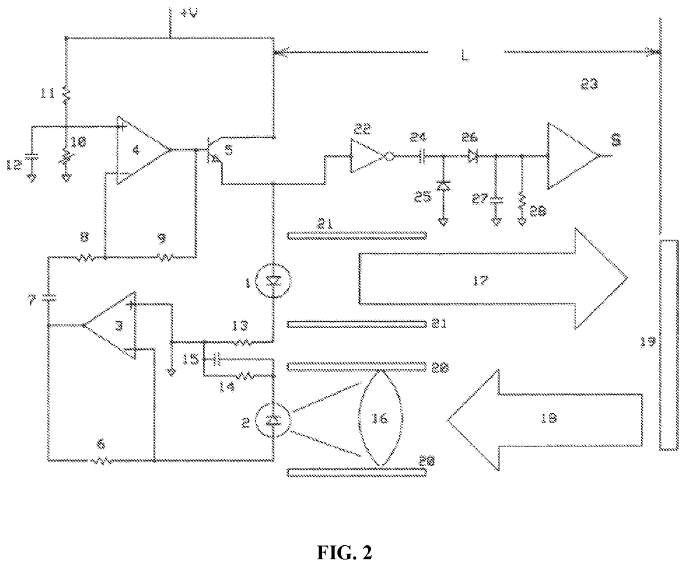

A second way to manipulate the information provided by the oscillator circuit is shown in FIG. 2, in this case an inverter is used (22) For receiving the signal generated at the emitter of the transistor (5), this transistor (5), acts as a current amplifier, which directly feeds the light emitting diode (1). The output of the inverter (22) is connected to the input capacitor (24), which in each rising cycle of the signal, pumps a certain amount of charge to the integrating capacitor (27) through the injection diode (26), during the lowering of the signal, the input capacitor (24), is discharged through the discharge diode (25) and begins again the process of pumping charge to the integrating capacitor (27), But since the voltage on the integrating capacitor (27) is each time to be greater, the amount of charge transferred by the input capacitor (24) to the integrating capacitor (27) each time being less, a curve being generated that compensates for the non-linearity of the relationship between the distance to the target (19) and the frequency generated by the feedback circuit, the resistor (28) serves to discharge the integrating capacitor (27) and an output amplifier (23), it has a high impedance to the integrating capacitor (27) and a low impedance at the output (S), allowing the output of the voltage signal through the integrating capacitor (27) without altering it, the gain of this output amplifier (23) is unity and only serves as an impedance coupler.

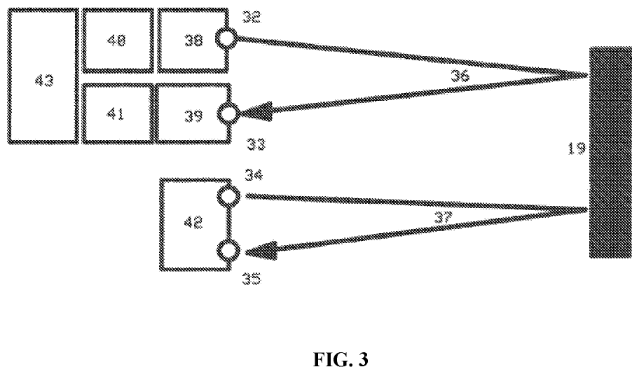

The main difference between an optical flight time meter for measuring conventional distances and our integral electro optical meter is illustrated in FIG. 3; the conventional meter has a much more complex architecture and requires ultra-high speed circuits, since this system must quantify the time it takes to a light pulse, reach the target and return to the meter, in FIG. 3 the conventional meter is constituted by a local oscillator (40), which generates frequency pulses which are amplified by the power amplifier (38) which powers the emitter (32) which is a laser diode emitting a light beam (36) which is caused to bounce in the target (19) or target for later being recorded by the sensor (33) which generates a signal which is amplified by the input amplifier (39) and activates an ultra-high speed timer (41) which together with the control circuit (43) determines the time it took the light pulse travels twice the distance between the meter and the target (19), since the speed of the light is extremely high, the times with which this type of system has to liquefy, are in the ranges of the femtoseconds and requires extremely sophisticated and expensive electronics, on the other hand.

In the lower part of FIG. 3, the solution is shown using the integral electro optical meter (42), in this case, there is basically a single circuit which performs all of the operation, an emitting element is used (34) which can be both a laser diode and an LED to emit a light signal which in this case is not a pulse but a sine signal continuous (37), which after bounce in the target (19), is read by the sensing element (35) which completes the positive feedback of the integral electro optic meter which generates a frequency proportional to the distance between the meter and the target.

As can be appreciated, the design of this invention, uses conventional low frequency and low cost circuitry and can operate at much shorter distances than conventional flight time optical systems, on the other hand, this circuit can work either with laser diodes of any type or with simple LEDs, so long as they are provided with the necessary assembly and collimation as described in the comments on FIGS. 1 and 2.

The circuit can also function appropriately with phototransistors in place of photodiodes, although the output frequency band is significantly reduced with the alternative to the use of the phototransistor, it is also important to discuss that the use of optical filters also allows to improve the performance of the integral electro optic meter.

1. An integral electrooptic distance meter comprising a high gain amplifier circuit, a light emitter, a light sensor, a linearizer circuit and a positive feedback device, characterized in that the high gain amplifier circuit is formed by two operational amplifiers configured as inverting amplifiers connected in a closed circuit comprising the light emitting device and the light sensing device forming a single positively feedback operating circuit, which is further characterized in that the positive feedback controlling the stability and hence the oscillation of the circuit is the forward path and turn on the light beam produced by the light emitter and which is returned to the object whose distance to the measuring device is to be measured.

2. The integral electro optic distance meter in accordance with claim 1, wherein the light sensor is characterized by being a photodiode while the light emitter is characterized by being a laser light emitting diode or a conventional LED.

3. The invention relates to an integral electrooptic distance meter in accordance with claim 1 wherein the linearizer circuit is characterized in that it is a microcontroller powered by a gate with Schmitt input And equipped with a program with reverse transfer function to the logarithmic natural response of the distance measuring circuit.

4. The integral electrooptic distance meter according to claim 1 wherein the linearizer circuit is characterized by being constituted by a charge pumping device formed by an input capacitor, an integrating capacitor, an injection diode, a discharge diode, a discharge resistor, a logic inverter with Schmitt input and an unity gain amplifier as an impedance coupler.
